(19) United States
(12) Patent Application Publication
(10) Pub. No.: US 2004/0173068 A1
(43) Pub. Date: Sep. 9, 2004

(54) Method for cutting continuous sheet

(75) Inventor: Nokihisa Adachi, Kasugai-shi (JP)

Correspondence Address: KODA & ANDROLIA, 2029 CENTURY PARK EAST, SUITE 1430, LOS ANGELES, CA, 90067-3024, US

(73) Assignee: Kabushiki Kaisha Isowa

(21) Appl. No.: 10/786,741

(22) Filed: Feb. 25, 2004

(30) Foreign Application Priority Data
Feb. 28, 2003 (JP) 2003-054533
Feb. 9, 2004 (JP) 2004-32305

(51) Int. Cl. B26D 3/00

(52) U.S. Cl. 83/13

(57) ABSTRACT

One object of the present invention is to provide a method for cutting a corrugated card board sheet in which continuous trimmed pieces are formed over an order change period, thereby preventing meandering of the sheet without increasing manufacturing cost.

A method in accordance with the present invention is a method for cutting a continuous work sheet being fed along a feed line of a cutting machine using a slitter which is disposed in the feed line and is moveable in upper and lower directions, wherein when the slitter is transferred from its previous cutting position to its new cutting position in response to an order change of the continuous work sheet, the continuous work sheet is cut in a manner that a trimmed piece forms a continuous strip, the method comprising: providing a trimming means disposed along the feed line in a position spaced apart from the slitter, the trimming means being movable in upper and lower directions, and the trimming means including a slitter blade being pivotable around an axis disposed vertically relative to the surface of the continuous work sheet, moving the slitter from its previous cutting position to a position spaced apart from the surface of the continuous work sheet, while moving the trimming means toward the cutting position for the continuous work sheet, whereby the trimming means cuts the trimmed piece formed by the slitter in the previous cutting process, and moving the slitter toward the cutting position for the continuous work sheet, while moving the trimming means from the cutting position for the continuous work sheet to a position spaced apart from the surface of the continuous work sheet, whereby the slitter begins to cut the continuous work sheet, whereby the trimmed piece is formed by the trimming means in such a manner that the trimmed piece formed in the previous cutting process and the trimmed piece formed in the new cutting process are continuous.

### BACKGROUND OF THE INVENTION

1. Field of the Invention

The present invention relates to a method for cutting a continuous sheet such as a corrugated cardboard sheet in which a continuous trimmed pieces are formed while a way of cutting the sheet is changed, thereby preventing meandering of the sheet without increasing manufacturing cost.

2. Prior Art

Conventionally, a continuous work sheet such as a corrugated cardboard sheet being fed in a feed line is cut along the feed line by slitters having a plurality of slitter blades. The plurality of slitters are movable between a loaded-level for cutting the corrugated cardboard sheet and an unloaded-level spaced apart from the surface of the corrugated cardboard sheet. The slitters are also movable in a cross-machine direction i.e., a direction at right angles relative to the feed line, in order to select one or more of the slitters, depending on the specifications related to the way of cutting the sheets. The selected slitters are moved to the loaded-level and used for the cutting process, while the other slitters are moved to the unloaded-level.

In the manufacturing line of the corrugated cardboard sheet, the corrugated cardboard sheet is continuously cut, and waste pieces of a sheet formed at both sides of the cardboard sheet, commonly referred as trimmed pieces, are collected in a specific mechanism such as a collection duct disposed downstream of the slitters.

In some types of paper processing machines which continue a cutting operation even while the way of cutting the sheets such as cut-out numbers or cut-out width to improve the efficiency of the machine is being changed, a setting-up operation is executed in a manner that the slitters are moved in a cross-machine direction from their previous cutting positions to their new cutting positions during the continuous cutting operation thereof. Since the corrugated cardboard sheet fed during such a setting-up period is wasted, it will be desirable to minimize or shorten the setting-up period.

Japanese Patent Application Laid-Open (Kokai) H10-86093-A1 discloses a method for cutting a corrugated cardboard sheet in which trimmed pieces are formed along the feed line while the way of cutting the sheets is being changed in order to prevent stuffing up of the trimmed pieces in collection ducts therefor.

According to this method, slitters commonly used in a previous cutting operation and a new cutting operation are moved in a cross-machine direction during a continuous cutting operation of the corrugated cardboard sheet. Thus, each of the slitters includes a disc-shaped slitter blade being pivotable around an axis disposed vertically relative to the surface of the corrugated cardboard sheet. According to this cutting method, the slitters are moved in a cross-machine direction from a previous cutting position to a new cutting position without being spaced apart from the surface of the corrugated cardboard sheet, thereby the setting-up period is short compared to that of the machine in which slitters are moved into the unloaded-level for a preparation for changing the way of cutting the sheets, and continuous trimmed pieces can be formed while the way of cutting the sheet is being changed.

However, this cutting method has the following disadvantages.

Firstly, in case of some configurations of cut sheets, it can be difficult to prevent meandering of the corrugated cardboard sheet. More particularly, each of the slitters is pivotably supported and the pivot angle is controlled during the movement thereof in a cross-machine direction, in order to decrease frictional resistance raised between the slitter and the corrugated cardboard sheet. However, in some setting of cut-out, due to the fact that the number of the slitters to be moved in one cross-machine direction is different from that to be moved in the opposite cross-machine direction, and the total distance by which slitters are to be moved in the one cross-machine direction is different from that which they are to be moved in opposite cross-machine direction, the corrugated cardboard sheet will start meandering while the way of cutting the sheet is being changed, which may cause the manufacturing line to stop.

On the other hand, the slitter which executes a trimming operation should be moved in a cross-machine direction while the way of cutting the sheet is being changed without being spaced apart from the corrugated cardboard sheet, in order to form continuous trimmed pieces which can be collected effectively in a collecting duct.

A second problem will arise from the fact that the slitters are commonly used for trimming and a normal cutting operation. More particularly, although the pair of slitters disposed outermost of the paper line will typically be used for trimming, another pair of slitters may instead be used for trimming depending on the order change. Thus, since any slitter which is expected to execute a trimming operation should be allowed to move in a cross-machine direction while the way of cutting the sheet is being changed in order to form continuous trimmed pieces, all of the slitters should be pivotable and controllable about their pivot angle, which causes an excess production cost.

### SUMMARY OF THE INVENTION

One object of the present invention is to provide a method for cutting a corrugated cardboard sheet in which continuous trimmed pieces are formed while a way of cutting the sheet is being changed, thereby preventing meandering of the sheet without increasing manufacturing cost.

The method in accordance with the present invention is a method for cutting a continuous work sheet being fed along a feed line of a cutting machine using a slitter which is disposed in the feed line and is moveable in upper and lower directions, wherein while the slitter is transferred from its previous cutting position to its new cutting position for a preparation for a change of a way of cutting the continuous work sheet from a previous way to a new way, the continuous work sheet is cut in a manner that trimmed pieces form a continuous strip, the method comprising the steps of:

providing a trimming means disposed along the feed line in a position spaced apart from the slitter, the trimming means being movable in upper and lower directions, and the trimming means including a slitter blade being pivotable around an axis disposed vertically relative to the surface of the continuous work sheet,

moving the slitter from its previous cutting position to a position spaced apart from the surface of the continuous work sheet, while moving the trimming means toward the cutting position for the continuous work sheet, whereby the trimming means cuts into the trimmed piece formed by the slitter in the previous way,

moving the slitter toward the cutting position for the continuous work sheet, while moving the trimming means from the cutting position for the continuous work sheet to a position spaced apart from the surface of the continuous work sheet, whereby the slitter begins to cut the continuous work sheet,

whereby the continuous work sheet is cut by the trimming means so as to bridge the trimmed piece formed in the previous way and the trimmed piece formed in the new way.

According to the invention described above, the trimming means being movable in upper and lower direction are independent of the slitters and exclusively used for trimming. The slitters used in the previous cutting process including that used for trimming are moved from the cutting position to a position spaced apart from the surface of the continuous work sheet, then moved toward the new cutting position for a new order while the trimming means are moved toward the surface of the continuous work sheet, whereby the continuous work sheet is cuts into trimmed pieces formed in the previous process. During a setting-up period in which slitters are moved from the previous cutting position to the new cutting position, the trimming operation of the continuous work sheet is done by the trimming means as it moves in the cross-machine direction. The slitters used in the new cutting process are then moved toward the cutting position for the continuous work sheet, and start to cut the continuous work sheet, while the trimming means are moved from the cutting position to a position spaced apart from the surface of the continuous work sheet.

The slitters are maintained in a spaced apart relationship with the continuous work sheet during the movement thereof in the cross-machine direction, which makes it possible to move the slitters faster, thereby shortening the setting-up period. The pivotably supported trimming means can form continuous trimmed pieces merely by cutting into previous and new trimmed pieces without having to position the trimming means exactly on the cutting line. Thereby production cost will be reduced compared to the case where all of the slitters are pivotable and controllable about their pivot angle.

One embodiment of the present invention further comprises the steps of:

moving the trimming means toward the cutting position for the continuous work sheet immediately before moving the slitter from its previous cutting position to the position spaced apart from the surface of the continuous work sheet,

moving the trimming means from the cutting position for the continuous work sheet to a position spaced apart from the surface of the continuous work sheet immediately after moving the slitter toward the cutting position for the continuous work sheet.

Another embodiment of the present invention further comprises the steps of:

moving the trimming means toward its cutting position for the continuous work sheet at the location upstream from the downstream end of the trimmed line formed by the slitter in the previous cutting process,

moving the trimming means from the cutting position for the continuous work sheet to a position spaced apart from the surface of the continuous work sheet at the location downstream from the upstream end of the trimmed line formed by the slitter in the new cutting process.

One embodiment of the present invention further comprises the step of moving the trimming means toward its cutting position for the continuous work sheet at the location outward of both of the trimmed lines formed by the slitter in the previous and the new cutting processes, respectively.

One embodiment of the present invention further comprises the steps of

providing a rotational driving means, the rotational driving means rotating the slitter blade of the trimming means around an axis disposed vertically relative to the surface of the continuous work sheet,

cutting the continuous work sheet by the trimming means in such a manner that a rotational position of the slitter blade of the trimming means is adjusted based on the feeding speed of the continuous work sheet and moving speed of the trimming means in the width direction of the continuous work sheet.

One embodiment of the present invention further comprises the step of providing the trimming means, the slitter, and a duct for containing the trimmed pieces therein, which are disposed in a direction from an upstream position toward a downstream position of the feed line of the continuous work sheet.

### BRIEF DESCRIPTION OF THE DRAWINGS

Embodiments of the present invention will now be described with reference to the drawings in which:

FIG. 1 is a side view of the corrugator machine of the embodiment of the present invention;

FIG. 2 is a front view of the slitter unit of the embodiment of the present invention;

FIG. 3 is a side view of the slitter blade unit of the embodiment of the present invention;

FIG. 4 is a front view of the trimming means of the embodiment of the present invention;

FIG. 5(a) is a side view of the trimming means of the embodiment of the present invention, and FIG. 5(b) is a plan view of the trimming blade showing its rotational movement action;

FIG. 6 is a block diagram of an example of a controlling device used for controlling the slitter shown in FIG. 1;

FIG. 7 is a flow diagram showing a process executed by the controlling device shown in FIG. 6; and

FIG. 8 is a plan view of the work sheet being cut by the slitter shown in FIG. 1.

### DETAILED DESCRIPTION OF THE PREFERRED EMBODIMENT

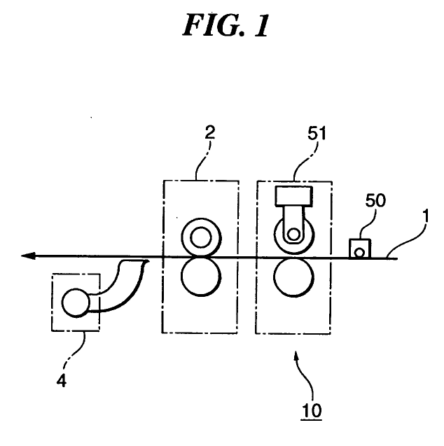

As can be seen in FIG. 1, a corrugated machine 10 of one embodiment of the present invention comprises a speed sensor 50 for detecting the speed V1 of a corrugated card board sheet 1, a trimming means 51, a slitter unit 2, and a trimmed piece collection duct 4, all of which are disposed from upstream of the feed line to downstream thereof.

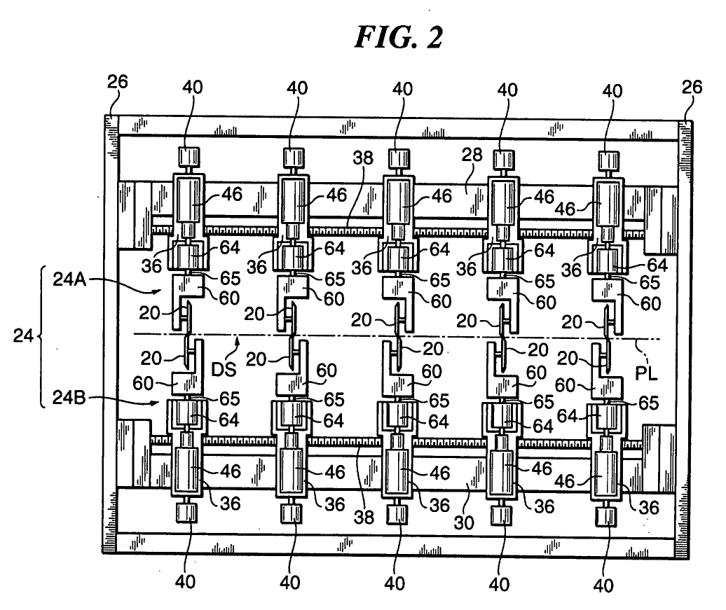

As can be seen in FIG. 2, a pair of beams 28 and 30 are disposed between frames 26 and 26 of the slitter unit 2 in parallel relationship to each other in such a manner that a paper feed line for the corrugated card board sheet is placed therebetween. The pair of beams 28 and 30 support a plurality of, in this embodiment, slitter blade units 24 which are spaced apart in a cross-machine direction. Each of the slitter blade units 24 includes an upper unit 24A and a lower unit 24B disposed respectively above and below the paper feed line PL for the corrugated cardboard sheet. Each of the slitter blade units 24 includes a pair of disc-shaped slitter blades 20 and 20 rotatable in opposite directions. The corrugated cardboard sheet supplied between the pair of slitters 20 and 20 in the feeding direction is cut therebetween. Since the upper unit 24A and the lower unit 24B are symmetrically disposed with respect to the paper feeding line PL of the corrugated cardboard sheet, reference will now be made to the upper unit 24A only and those elements of the lower unit 24B which are the same as or similar to those of the upper unit 24A will be referred to by the same numerals as those of the upper unit 24A.

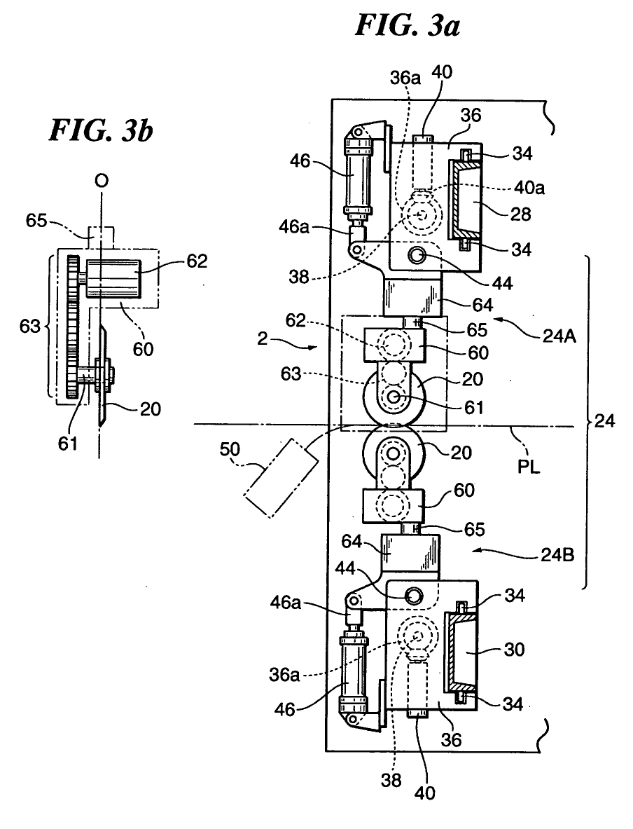

As can be seen in FIG. 3, the upper unit 24A includes the disc-shaped slitter blade 20, a rotational driving means for rotationally driving the slitter blade 20, a moving mechanism for moving the slitter blade 20 in a cross-machine direction, and an up/down moving mechanism for moving the slitter blade 20 between a loaded-level and an unloaded-level.

The slitter blade 20 is generally disposed in a vertical position relative to the surface of the corrugated cardboard sheet, and is rotatably supported on an axis 61 which is disposed in a cross-machine direction in a lower casing 60. A rotational driving mechanism including a motor 62 disposed in the lower casing 60 and a transmission mechanism 63 such as gears rotates the slitter blades. Trimmed pieces T having a desired width are formed at both sides of the corrugated card board sheet, by a pair of slitter blades 20 and 20 located at an outermost part of the slitter unit 2, and the trimmed pieces T formed thereby are collected in the collection duct 4.

The moving mechanism for a movement in a cross-machine direction includes the same number of moving members 36 as those of the slitter blade 20 attached to the upper beam 28 via rollers 34 and 34. The moving member 36 includes a nut 36a threadably engaged with a thread shaft 38 disposed between the frames 26 and 26. When each of servo motors 40 used as an actuator for a respective moving member 36 is driven, the nut 36a is rotationally driven by the engagement of the gear 40a of the motor with the gear 36b of the nut 36a, whereby each of the moving members 36 and thus each of the slitter blades 20 are positioned in a cross-machine direction.

As can be seen in FIG. 3, the moving mechanism for up/down movement includes an upper casing 64 pivotably supported via a shaft 44 disposed at a lower portion of the moving member 36. The upper casing 64 is connected to a piston rod 46a of a cylinder. When the piston rod 46a makes one stroke, the upper casing 64 and the slitter blade 20 are pivotably moved between its loaded-level and its unloaded-level.

All of the slitter blades 20 including those having been used for the trimming operation of the corrugated cardboard sheet are once moved to their unloaded-level after the cutting operation thereof in the previous cutting process is finished, then moved toward the new cutting position in the cross-machine direction, and thereafter moved to the loaded-level for the new cutting process of the corrugated cardboard sheet.

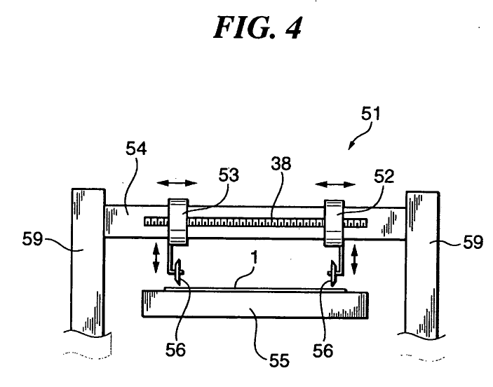

As can be seen in FIG. 4, the trimming means 51 includes a pair of heads 52 and 53 disposed above/at respective outermost positions of/on the corrugated cardboard sheet 1 when the heads 52 and 53 are not/are in use, each of which heads 52 and 53 respectively includes a disc-shaped thin cutting blade 56, a moving mechanism for moving the cutting blade 56 in the cross-machine direction, and a moving mechanism for moving the cutting blade 56 in upper and/or lower directions. The trimming means 51 are moveably supported on the beam 54 supported on both sides of the frames 59 and 59.

A roller 55 being formed of urethane is disposed on the side opposite to that on which the heads 52 and 53 are disposed of the corrugated cardboard sheet. The urethane roller 55 is rotationally driven by a motor (not shown) in such a manner that its circumferential speed is substantially the same as the feeding speed of the corrugated cardboard sheet 1. The trimming means 51 may also be disposed on a downstream portion of the slitter 2 instead of being disposed on an upstream portion thereof. Also, the urethane roller 55 can be replaced by a roller with a brush attached thereon, or a disc having a slit which corresponds to the cutting blade 56.

Since the heads 52 and 53 are similarly constructed, the structure of only the head 52 will be explained below. The head 52 includes a disc-shaped thin cutting blade 56 which is rotationally supported on a supporting axis 58. The supporting axis 58 is attached to the pivot member 60. The cutting blade 56 may be rotationally driven by a motor (not shown).

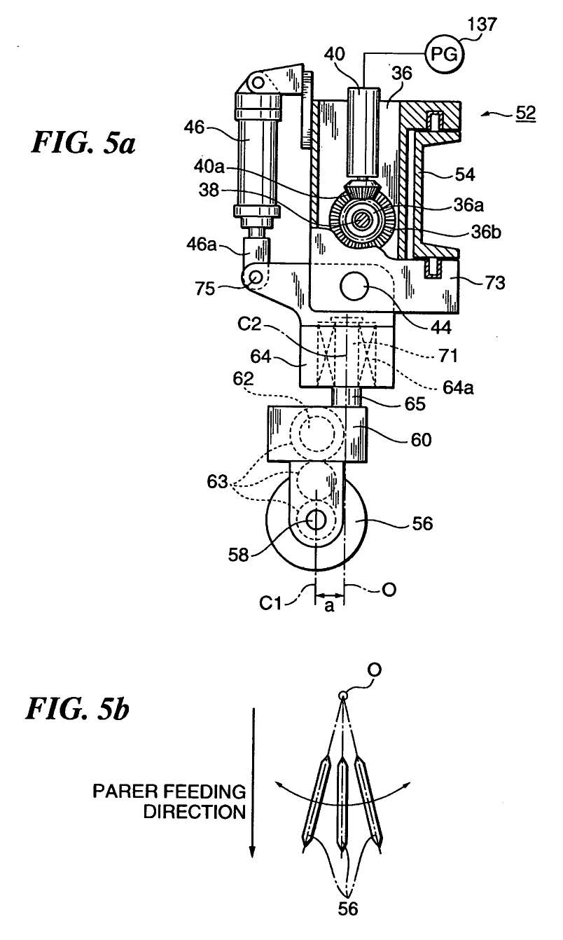

The pivot member 60 includes a pivot shaft 71 disposed vertically relative to the corrugated cardboard sheet, the pivot shaft 71 being supported on a bracket 64 via a bearing 64a. The lower casing 60 disposed below the upper casing 64 is supported by an axis 65 which is rotatably supported via the bearing 64a in the upper casing 64. Therefore, as can be seen in FIG. 5(b), the cutting blade 56 is pivotable around an axis O disposed vertically relative to the surface of the corrugated cardboard sheet. A center C1 of the supporting axis 58 and a center C2 of the pivot axis 71 are disposed to have an offset by a distance ‘a’ in such a manner that the distance ‘a’ is measured in the downstream direction of the feed line of the corrugated paper board sheet. Since the frictional or resistance force which is applied to the cutting blade 56 when the cutting operation of the corrugated cardboard sheet is performed is likely to be exerted on a portion of the cutting blade 56 offset from the center O of the axis, a smooth pivot movement of the cutting blade 56 is caused around the axis. When the cutting blade 56 is performing the cutting operation in order to form continuous trimmed pieces, the angle with respect to this pivot movement is automatically adjusted in accordance with the feeding speed of the corrugated cardboard sheet and moving speed of the cutting blade 56 in the cross-machine direction.

Since the structures of the moving mechanism for moving the cutting blade 56 in the cross-machine direction and the moving mechanism for moving the cutting blade 56 in upper and/or lower directions are similar to those of the slitter unit 2 described above, the same or corresponding elements therein are referred to by the same numeral and no detailed explanations are given. Trimming means may be moved in upper and lower directions at the speed of about 0.5 m/sec, and moved in the cross-machine direction at the speed of about 1.0 m/sec.

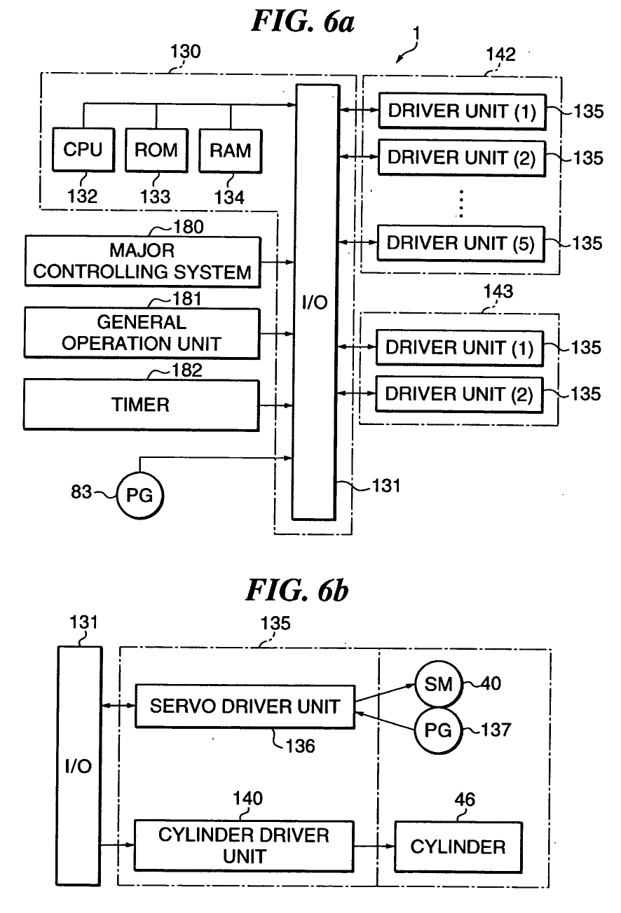

FIG. 6 is a block diagram of a controlling device used for controlling the slitter. As can be seen in FIG. 6(a), this slitter controlling device 1 includes a controlling section 130 including an I/O port 131, a CPU 132, a ROM 133, and a RAM 134, all of which are connected to the I/O port 131. The ROM 133 has a controlling program stored therein used for controlling the slitter. A major controlling system 180 is also connected to the I/O port 131. The major controlling system 180 controls all of the elements of the corrugated cardboard sheet production line, and maintains order specification data such as cut-out numbers or cut-out width in the memory thereof. The major controlling system 180 transmits data of a new order to the slitters when the way of cutting the sheet is changed.

A general operation unit 181 including a keyboard and/or a touch-panel and a timer 182 is connected to the I/O port 131. Also, a driving unit 142 for driving each of the slitter units 2 and a driving unit 143 for driving each of the trimming means are connected to the I/O port 131. The driving unit 142 includes the same numbers of driver units 135 as the slitter blade units 24. The driving unit 143 includes two driver units 135, each of which corresponds to the trimming means. Each of the driver units 135 includes a servo driver unit 136 and a cylinder driver unit 140 which are connected to the I/O port 131, as shown in FIG. 6(b). The servo driver unit 136 is connected to a servo motor 40 and a pulse generator 137 for the slitter blade unit 24. The servo motor 40 controls the movement of the slitter blade unit 24. The pulse generator 137 detects a current position in the cross-machine direction of the slitter blade 20 of the slitter blade unit 24, which data is sent to the servo driver unit 136. The cylinder driver unit 140 is connected to the cylinder 46 which moves the slitter blade 20 to a loaded or unloaded level. A pulse generator 83 (see FIG. 6(a)) for detecting the rotational speed of the feeding roller for the corrugated cardboard sheet is connected to the I/O port 131, and the data of the feeding speed of the sheet is sent to the I/O port 131.

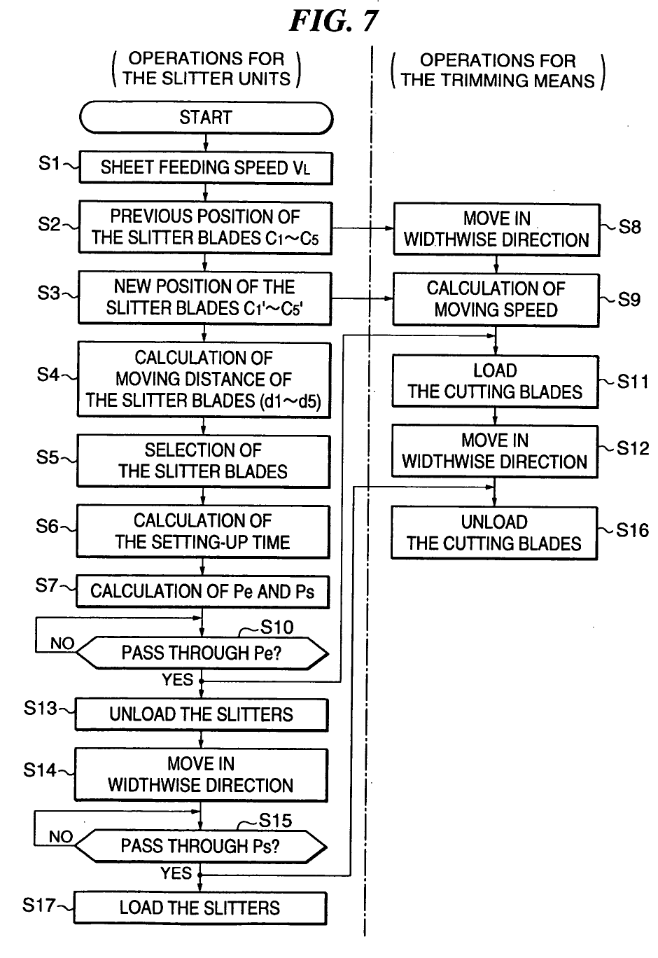

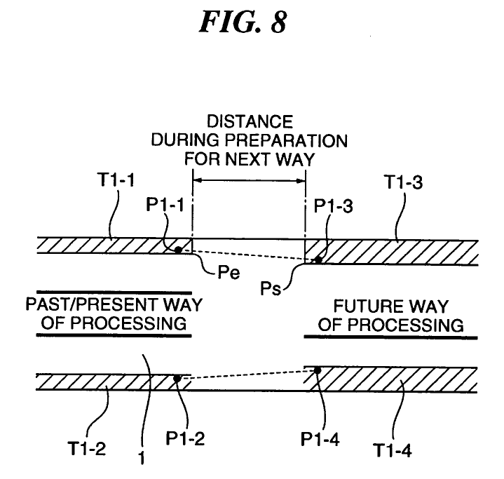

The operation of the slitters before, during, and after the way of cutting the sheet is changed will now be explained below. During a cutting operation of the slitters, a major controlling system 180 shown in FIG. 6 accepts a signal for the order change, thereby setting a point Pe for starting to change the way of cutting the sheet. In one embodiment of the present invention described below, it is assumed that the previous way of cutting is 3-outs and the new one is 2-outs, and width TM of the trimmed pieces in the new order is wider in the cross-machine direction than that of the previous order. FIG. 7 is a flow diagram showing process executed by the controlling device shown in FIG. 6, and FIG. 8 is a plan view of the work sheet being cut by the slitter shown in FIG. 1.

During the previous way of cutting the sheet, the cutting operation of the corrugated cardboard sheet is done by each of the slitter blades 20 of the respective slitters 2 located at the cutting position defined by the way of cutting the sheet. As can be seen in FIG. 8, while the previous way of cutting the sheet is performed, i.e., 3-out forming of the corrugated cardboard sheet 1, trimmed pieces T1-1 and T1-2 are cut by the slitter heads 20A and 20B located at the outermost positions of the corrugated cardboard sheet 1. In the steps of S1 to S3 shown in FIG. 7, the major controlling system 180 sends to the CPU 132 data including location data for each of the slitter blades 20 of the respective slitter units 2. This data includes location data C1 to C5 defining the position of each of the slitter blades 20 in the previous way of cutting the sheet, and location data C1′ to C5′ defining the position of each of the slitter blades 20 in the new way of cutting the sheet. The feeding speed VL of the corrugated cardboard sheet is also detected by the pulse generator 83 (see FIG. 6) and sent to the CPU 132. In an alternative embodiment of the present invention, the location data C1′ to C5′ needed for the new way of cutting the sheet is calculated based on specific data such as the cut-out number, width of the corrugated cardboard sheet, width of the flap, and width of the trimmed pieces.

In the step of S4 shown in FIG. 7, the distances in the cross-machine direction by which each of the slitter blades 20 should be moved from the previous position where the previous way of cutting the sheet is performed to the new position where the new way of cutting the sheet is performed are calculated by comparing previous location data C1 to C5 and new location data C1′ to C5′. In the step S5, the slitter blades 20 used in the new way are selected while one or more of the slitter blades 20 does not need to be used in the new way, and such slitter blades 20 are unloaded. In the step S6, the setting up time Tc which is the time period needed to reposition all of the slitter blades 20 from the previous position to the new position is calculated. This time period is calculated with reference to the slitter blade which is to be moved a longer distance than any of the other blades. In the step S7, the position Ps shown in FIG. 8 is calculated based on the feeding speed data VL detected by the speed sensor 50 and the setting up time Tc.

In the step S8, the cutting blades 56 of the trimming means 51 are moved in the cross-machine position where the slitters are now forming the trimmed pieces. More particularly, the heads 52 and 53 are positioned via the servo motor 40, the bevel gears 40a and 36a, the nut 36b, and the threaded shaft 38. The heads 52 and 53 are positioned at almost the same locations as those that the upper and lower slitter heads 20 are positioned at in the previous cutting process for the corrugated cardboard sheet 1.

In the step S9, the distance by which the cutting blade 56 is to be moved for the new cutting process is calculated based on the position data for the slitter which is to be used for trimming during the new cutting process. This distance data is divided by the setting up time Tc, whereby the moving speed of the cutting blade 56 in the cross-machine direction while the way of cutting the sheet is being changed is calculated.

In the step S10, if it is detected that the corrugated cardboard sheet being fed has passed through the point Pe, then the slitter blade 20 is moved to its unloaded-level (see S13), while on the other hand, the cutting blade 56 is moved to its loaded-level (see S11) in order to execute an trimming operation thereby. More particularly, the movement of the cutting blade 56 toward the corrugated cardboard sheet 1 is started before the trimming means 51 reaches the point Pe by the prediction based on the speed data of the speed sensor 50. The cutting blade 56 is moved in such a manner that the piston 46 is driven, which causes the movement of the bracket 64, which causes the movement of the pivot member 60 and the cutting blade 56.

In a case where the way of cutting the sheet is changed, the cutting blades 56 start their cutting operation immediately before the point Pe. This is accomplished by positioning the cutting blades 56 on or adjacent to each of the cutting slits formed in the corrugated cardboard sheet by the slitter blades 20. The cutting blades 56 are moved toward a loaded level at a high speed such as 0.5 m/sec. Each of the cutting blades 56 starts cutting the corrugated cardboard sheet 1 from the points P1-1 and P1-2, respectively. The corrugated cardboard sheet 1 is cut by the cutting blades 56 and the urethane roller 55, shown by a dotted line in FIG. 8. It is preferable to move the cutting blades 56 to their loaded-level immediately before the point Pe is passed through in order to make sure that the cutting blades 56 cut into the trimmed pieces formed in the previous cutting operation.

In the step S12, the cutting blades 56 are moved in the cross-machine direction during the cutting operation of the corrugated cardboard sheet. More particularly, the heads 52 and 53 are moved from the previous cutting position where the trimmed pieces T1-1 and T1-2 are formed thereby to the new cutting position Ps where the trimmed pieces T1-3 and T1-4 are formed thereby. The heads 52 and 53 are moved via the rotation of the servo motor 40, bevel gears 40a and 36a, and the threaded shaft 38, at a moving speed of about 1 m/sec.

During the movement of the cutting blades 56, since the corrugated cardboard sheet 1 is continuously fed, a frictional and/or resistance force arising between the cutting blades 56 and the corrugated cardboard sheet 1 will act on the cutting blades 56, and at the same time, a frictional and/or resistance force arising due to the movement of the cutting blades 56 will also act on the cutting blades 56. Thus, the cutting blades 56 are pivoted around the axis 65 by both of the forces, and oriented in the direction parallel to the sum of such forces.

In an alternative embodiment of the present invention, the orientation of the cutting blades 56 in its cross-machine movement may be driven by a servo motor (not shown) controlled by numeral data. In such an embodiment, the orientation of the cutting blade 56 in its cross-machine movement may be controlled in such a manner that a tan⁻¹(V2/V1) is calculated, where V1 is the feeding speed of the corrugated cardboard sheet 1, and V2 is the moving speed of the cutting blade 56 in the cross-machine direction, thereby maintaining the orientation of the cutting blade 56 at an angle tan⁻¹(V2/V1) relative to the feeding direction of the corrugated cardboard sheet 1.

Therefore, as shown by a dotted line in FIG. 8, the cutting blades 56 cut the corrugated cardboard sheet from its trimmed pieces formed in the previous cutting process to its trimmed pieces formed in the new cutting process, so as to bridge the trimmed pieces formed in the previous cutting process and those formed in the new cutting process, whereby continuous trimmed pieces are created.

In the step S15 shown in FIG. 7, when the cutting blades 56 pass through the point Ps, the slitter blades 20 are moved to the loaded-level (see S17), while on the other hand, the cutting blades 56 are moved to the unloaded-level (see S16). More particularly, when the cutting blades 56 pass through the point Ps, or when the cutting blades 56 reach the end points P1-3 and P1-4 located a small distance apart outwardly from the point Ps, the cutting blades 56 are moved toward a position spaced apart from the surface of the corrugated cardboard sheet 1, i.e., an unloaded level via the piston 46, the bracket 64, and the pivot member 60. Preferably, the cutting blades 56 are moved to the unloaded-level thereof immediately after they have passed through the point Ps in order to assure that they reliably cut into the trimmed pieces formed in the new cutting operation.

The repositioning of the upper and lower slitter heads is accomplished at the point Ps. The trimmed pieces T1-3 and T1-4 are now formed by the slitter blades 20. Thereafter, the cutting operation for the new way of cutting the sheet is accomplished by the slitter 2. According to this embodiment, the way of cutting the sheet is assumed to execute a 2-out cutting operation, as described above, so that one or more of the slitter heads 20 are maintained in their unloaded or rest level.

In the embodiment shown in FIG. 8, during the cross-machine movement of the cutting blades 56, the orientations of the cutting blades 56 are in directions opposite to each other so that the cutting blades 56 move inwardly during the cutting operation of the corrugated cardboard sheet. Therefore, the forces being applied to the corrugated cardboard sheet by both sides of the cutting blades 56 in the cross-machine direction can cancel each other, thereby effectively preventing meandering of the corrugated cardboard sheet.

When the trimmed pieces T1-1 and T1-2 formed in the previous cutting process reach the collection duct 4, the trimmed pieces T1-1 and T1-2 are collected into the collection duct 4 for example by sucking. While the way of cutting the sheet is being changed, the trimmed pieces continuously formed with the trimmed pieces T1-1 and T1-2 by the cutting blades 56 are collected into the collection duct 4. Thereafter, the trimmed pieces T1-3 and T1-4 formed in the new way are collected into the collection duct 4.

Since all of the trimmed pieces T1-1, T1-2, T1-3 and T1-4 are continuously collected into the collection duct 4, jamming-up of the corrugated cardboard sheet is effectively prevented. As long as the starting points P1-1 and P1-2 are located proximal to the point Pe and the ending points P1-3 and P1-4 are located proximal to the point Ps, even if the cutting lines formed by the slitters while the previous way of cutting the sheet is performed and the cutting lines formed by the cutting blades while the next way of cutting the sheet is performed are not exactly connected, such connecting portion will be torn when the trimmed pieces are collected into the collection duct 4, and all of the trimmed pieces will be effectively collected therein, thereby preventing the jamming-up of the corrugated cardboard sheet. Thus, positioning of the cutting blades 56 is not very critical, which may reduce cost needed for the positioning devices for the cutting blades 56.

Those skilled in the art will understand that many modifications and variations can be made with respect to the embodiment described above without departing from the scope of the invention defined by accompanying claims. For example, although the embodiment described above is explained with respect to the corrugated cardboard sheet, it is obvious that the present invention can be applied to any continuous work sheet which is to be cut according to the way of cutting the sheet such as cut-out numbers and/or cut-out width is changed. Also, although the embodiment described above utilizes disc-shaped thin blades as the cutting blades, conventional knife-shaped blades which are pivotably supported may be utilized instead of the disc-shaped cutting blades 56. Furthermore, although the embodiment described above utilizes only one slitter unit in the corrugated machine, the present invention may apply to any machine having two or more slitter units. In such embodiments, two sets of slitter units may be used in previous or new cutting operations, and those slitter units can be controlled in accordance with the present invention described herein.

What is claimed is:

1. A method for cutting a continuous work sheet being fed along a feed line of a cutting machine using a slitter which is disposed in the feed line and is moveable in upper and lower directions, wherein while the slitter is transferred from its previous cutting position to its new cutting position for a preparation for a change of a way of cutting the continuous work sheet from a previous way to a new way, the continuous work sheet is cut in such a manner that trimmed pieces form a continuous strip, said method comprising:
providing a trimming means disposed along the feed line in a position spaced apart from said slitter, said trimming means being movable in upper and lower directions, and said trimming means including a slitter blade being pivotable around an axis disposed vertically relative to the surface of said continuous work sheet,
moving said slitter from its previous cutting position to a position spaced apart from the surface of the continuous work sheet, while moving said trimming means toward the cutting position for the continuous work sheet, whereby said trimming means cuts into the trimmed pieces formed by said slitter in the previous way,
moving said slitter toward the cutting position for the continuous work sheet, while moving said trimming means from the cutting position for the continuous work sheet to a position spaced apart from the surface of the continuous work sheet, whereby said slitter begins to cut the continuous work sheet,
whereby the continuous work sheet is cut by said trimming means so as to bridge the trimmed piece formed in the previous way and the trimmed piece formed in the new way.

2. The cutting method recited in claim 1 further comprising the steps of:
moving said trimming means toward the cutting position for the continuous work sheet immediately before moving said slitter from its previous cutting position to the position spaced apart from the surface of the continuous work sheet,
moving said trimming means from the cutting position for the continuous work sheet to a position spaced apart from the surface of the continuous work sheet immediately after moving said slitter toward the cutting position for the continuous work sheet.

3. The cutting method recited in claim 1 further comprising the steps of:
moving said trimming means toward its cutting position for the continuous work sheet at a location upstream from the downstream end of the trimmed line formed by said slitter in the previous cutting process,
moving said trimming means from the cutting position for the continuous work sheet to a position spaced apart from the surface of the continuous work sheet at a location downstream from the upstream end of the trimmed line formed by said slitter in the new cutting process.

4. The cutting method recited in claim 1 further comprising the step of moving said trimming means toward its cutting position for the continuous work sheet at the location outward of both of the trimmed lines formed by said slitter in the previous and the new cutting processes, respectively.

5. The cutting method recited in claims 1 or 2 further comprising the steps of:
providing a rotational driving means, said rotational driving means rotating said slitter blade of the trimming means around an axis disposed vertically relative to the surface of said continuous work sheet,
cutting the continuous work sheet by said trimming means in a manner that a rotational position of said slitter blade of the trimming means is adjusted based on the feeding speed of the continuous work sheet and moving speed of the said trimming means in the width direction of the continuous work sheet.

6. The cutting method recited in claim 1 further comprising the step of providing said trimming means, said slitter, and a duct for containing the trimmed pieces therein, which are disposed in a direction from an upstream position toward a downstream position of the feed line of the continuous work sheet.
